(19) United States
(12) Patent Application Publication
(10) Pub. No.: US 2008/0053427 A1
(43) Pub. Date: Mar. 6, 2008

(54) VERSATILE FOOD COOKING GRILL AND GRILL FEATURES

(76) Inventor: Diana B. McGinness, Bellingham, WA (US)

Correspondence Address: PERKINS COIE LLP;PATENT-SEA, P.O. BOX 1247, SEATTLE, WA, 98111-1247, US

(21) Appl. No.: 11/835,374

(22) Filed: Aug. 7, 2007

Related U.S. Application Data
(60) Provisional application No. 60/836,205, filed on Aug. 7, 2006.

(51) Int. Cl. A47J 37/06; F24C 15/08

(52) U.S. Cl. 126/50; 126/25 R

(57) ABSTRACT

An alternative fuel source may be utilized within a grill via a removable alternative fuel tray that may be placed between a cooking surface and a primary heat source to replace the primary heat source. A working surface may be formed between two connected grill legs or firebox assemblies resulting in an approximately L-shaped grill, suitable for use in a corner. In some embodiments, the grill may include a warming/indirect heat shelf that may be suitable to keep cooked foods warm and/or may provide an additional cooking surface.

### CROSS-REFERENCE TO RELATED APPLICATIONS

This patent application claims the benefit of U.S. Provisional Patent Application No. 60/836,205, entitled “VERSITILE CORNER GRILL AND GRILL FEATURES,” filed Aug. 7, 2006, which is herein incorporated by reference.

### BACKGROUND

The typical homeowner may have only the usual 9×12 foot deck, and a typical apartment renter may have only a balcony deck of 4×6 feet. Both present problems when attempting to entertain utilizing a grill that requires upwards of 5-6 feet in length and up to 3 feet in depth. Much of the deck space is utilized for the grill, not people.

Most of today's grills are either gas or charcoal, requiring a purchaser of a grill to choose between the efficiency and convenience of a gas grill, and the traditional flavors and aroma's associated with charcoal grilling.

Various meats are best cooked utilizing an indirect fuel source allowing the meat to slowly cook after searing to seal in the juices. With typical grills, the preparer must either place the meat off to the side of the grill or move the coals away from the meat to allow for indirect cooking. Too often, there's little room to accommodate indirect cooking unless that is the sole meat being prepared.

### SUMMARY

Various aspects of versatile grilling technologies are described herein. In some embodiments, a corner grill is designed to fit into a 90-degree corner of a deck, thereby freeing up space typically taken by today's grills. Because of its efficient space utilization, the corner grill can be narrower than today's grills. The corner grill can include either a single grilling space (e.g., right or left handed) or multiple grilling spaces. Various lengths and dimensions of the corner grill can be manufactured in order to increase the cooking surface of the grill.

In some embodiments, the versatile grilling technology offers features for using alternative fuel sources, such as charcoal and/or wood chips, in a gas grill. This may involve inserting a removable alternative fuel tray directly over the gas burner/heat displacer of the gas grill. While a removable alternative fuel tray may be sold as a feature of a specially-designed gas/charcoal grill, the removable alternative fuel tray could also be designed to accommodate existing gas-only grills. For example the removable alternative fuel tray may be configured as a fuel tray/grill grate assembly/combination configured to replace a plain grate/cooking surface in a standard gas grill. The removable alternative fuel tray is configured for easy insertion/removal (e.g., via the use of handles and other easy to use features). This allows for easy conversion from gas to the alternative fuel, easy insertion/removal of new alternative fuel (e.g., charcoal), and easy clean up of spent alternative fuel (e.g., charcoal ashes).

In some embodiments, the grilling technology includes an indirect cooking shelf for those meats better prepared in this fashion. Furthermore, the indirect cooking surface can be utilized for preparing vegetables and other foods, and/or as a food warmer.

### BRIEF DESCRIPTION OF THE DRAWINGS

FIG. 1 is a side elevation view of a sample double corner grill assembly.

FIG. 2 a side elevation view of a sample single corner grill assembly.

FIG. 3 is a top plan view of the sample double corner grill assembly of FIG. 1.

FIG. 4 is a top plan view of the sample single corner grill assembly of FIG. 2.

FIG. 5 is a top plan view of a sample combination indirect/warming and grilling surface for a double corner grill assembly.

FIG. 6 is a top plan view of a sample indirect/warming shelf and grill surface for a single corner grill assembly.

FIG. 7 is a side plan view of a sample firebox for a grill assembly.

FIG. 8 is a side elevation view of the sample grill assembly firebox of FIG. 7, with an alternative fuel tray/grill grate assembly inserted.

FIG. 9 is a side elevation view of the disassembled alternative fuel tray/grill assembly shown in FIG. 8.

FIG. 10 is an enlarged side plan view of a sample fuel tray handle and fuel tray support member of the alternative fuel tray/grill assembly shown in FIGS. 8 and 9.

### DETAILED DESCRIPTION

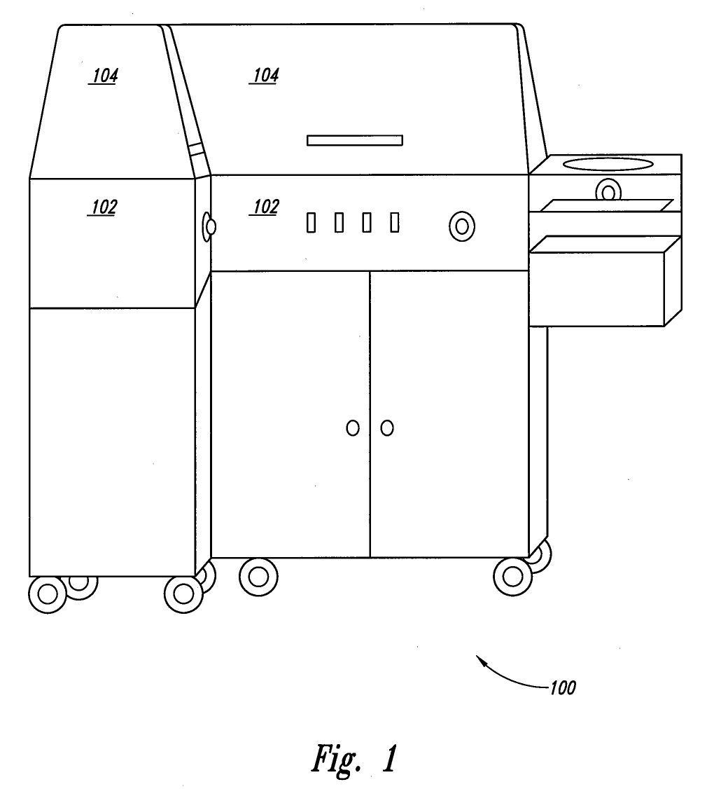

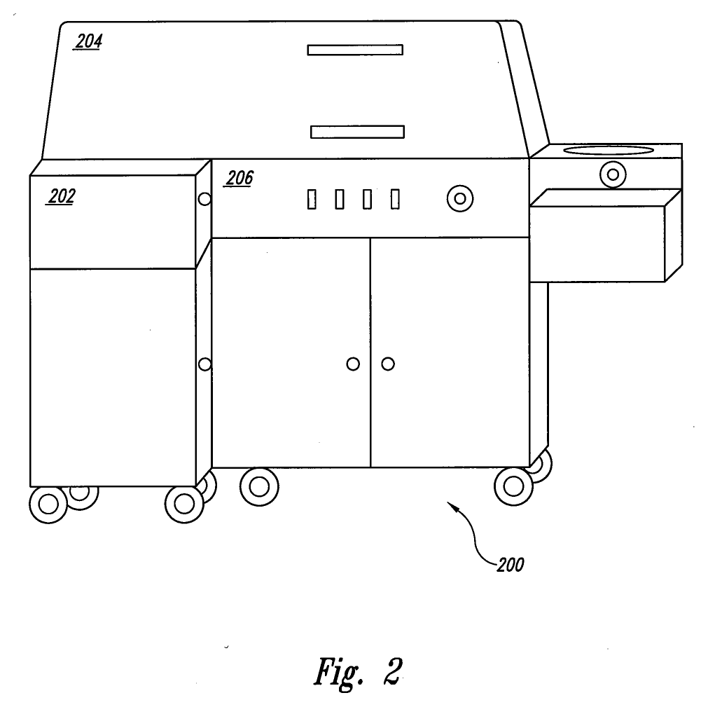

In reference to the drawings in detail, FIG. 1 is a side elevation view of a sample double corner grill assembly 100 and FIG. 2 is a side elevation view of a sample single corner grill assembly 200. In general, to construct the double corner grill assembly 100 or the single corner grill assembly 200, two grill legs comprising any one or more of firebox assemblies (including heating elements, heat distribution surfaces, etc), cooking surfaces, storage shelves, warming shelves, hoods, grill covers, etc., are joined or otherwise connected and oriented in an approximate L-shape, thereby forming a working area between them. Thus, both the double corner grill assembly 100 and the single corner grill assembly 200 are configured to allow those with limited space or those who would prefer to limit the amount of space required for a grill the option of doing so.

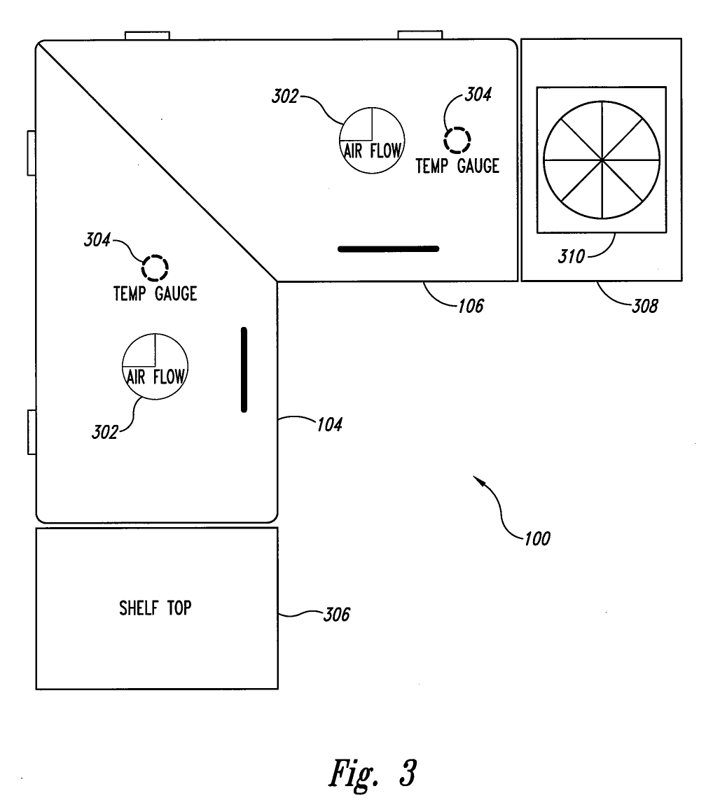

In one embodiment, as depicted in FIG. 1, the 90-degree corner in the grill is accomplished for the double grill assembly 100 by manufacturing the fireboxes 102 and grill covers (104 and 106) with a 45-degree angle at their joining surface, as shown in more detail with respect to FIG. 3. The double grill assembly 100 increases the cooking surface by two so that even with a shorter and narrower grill, the cooking surface would equal that of much larger grills. For those not requiring the increased cooking surface, the singe grill assembly 200 may utilize a cabinet 202 in conjunction with a grill cover 204 and firebox 206 to create the 90-degree corner, thus, providing additional space for storage of charcoal, charcoal insert trays, utensils, cleaning supplies, or other items. The single grill assembly 200 could be either right- or left-handed.

While FIG. 2 depicts a single grill assembly 200 and FIG. 1 depicts a double grill assembly 100, one skilled in the art would recognize that other configurations of a multiple grill assembly may be implemented without departing from the scope of the invention. For example, grill assemblies having more than two grills and or warming surfaces may be used, along with grills/warming surfaces of multiple heights, orientations, dimensions, etc.

FIG. 3 is a top plan view of the sample double corner grill assembly 100 of FIG. 1. In this example, the two grill covers (104 and 106) meet each other at a 45-degree angle so that the grill assembly maintains a 90-degree corner. Underneath each of the two grill covers (104 and 106) is a grilling surface and firebox (not shown), as well as a temperature gauge feature 302 and an airflow feature 304. In this example a shelf surface 306 extends outward past the first grill cover 104 and a side burner 308 extends outward past the second grill cover 106. The shelf top 306 and underlying cabinet space below each of the fireboxes (not shown) can be utilized for storage of charcoal or other accessories. The side burner 308 can be used for side dish/sauce preparation and may include a cover for the burner 310.

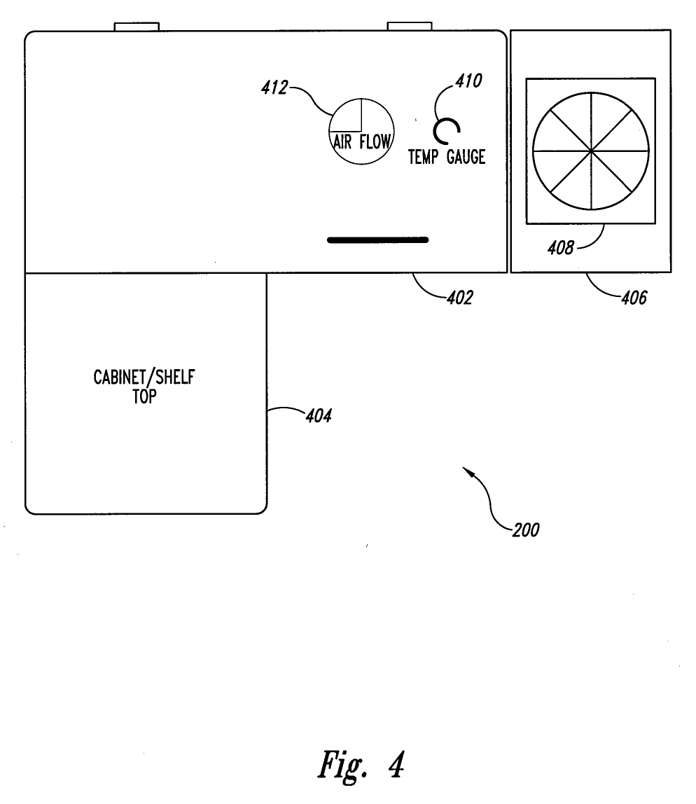

FIG. 4 is a top plan view of the sample single corner grill assembly 200 of FIG. 2. It may include similar features as the double grill assembly including a grill cover 402, a cabinet/shelf top 404 that extends outward past one side of the grill cover 402, and a side burner 406 (including a burner cover 408) that extends outward past the other side of the grill cover 402. As with the double corner grill assembly 100, the single corner grill assembly 200 may include a temperature gauge feature 410 and an airflow feature 412 located somewhere underneath the grill cover 402.

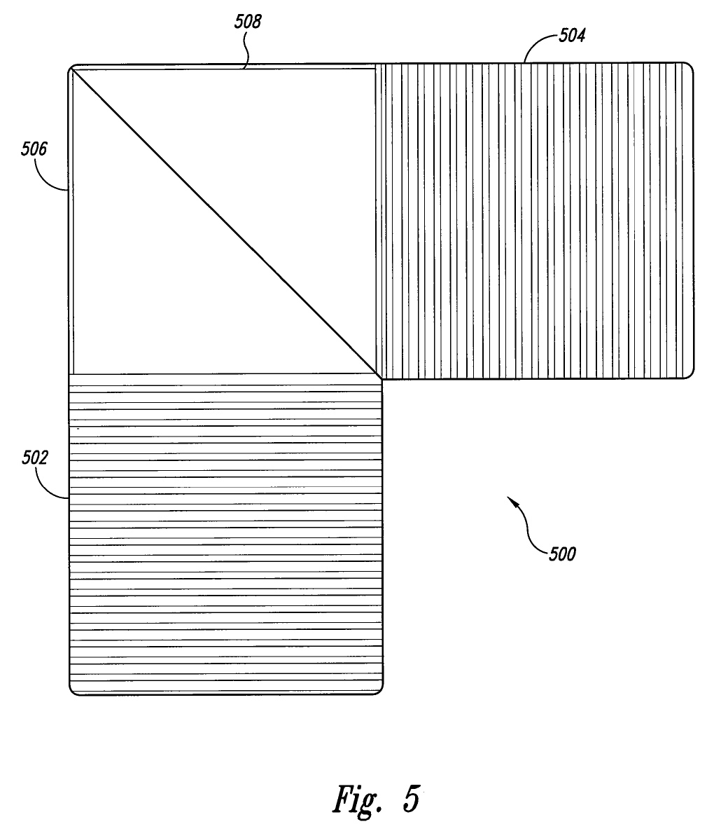

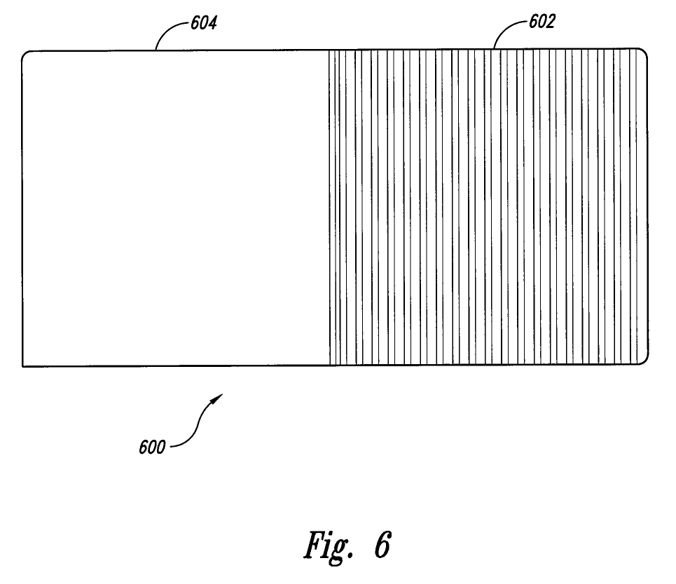

FIG. 5 is a top plan view of a sample combination indirect/warming and grilling surface for a double corner grill assembly 500 having two separate grilling surfaces (502 and 504) and two separate indirect/warming surfaces (506 and 508). Each of the indirect/warming shelves (506 and 508) provides a separate indirect/warming area for its corresponding grilling surfaces (502 and 504, respectively). FIG. 6 is a top plan view of a sample indirect/warming shelf and grilling surface for a single corner grill assembly 600 having a single grilling surface 602 and a single indirect/warming surface 604.

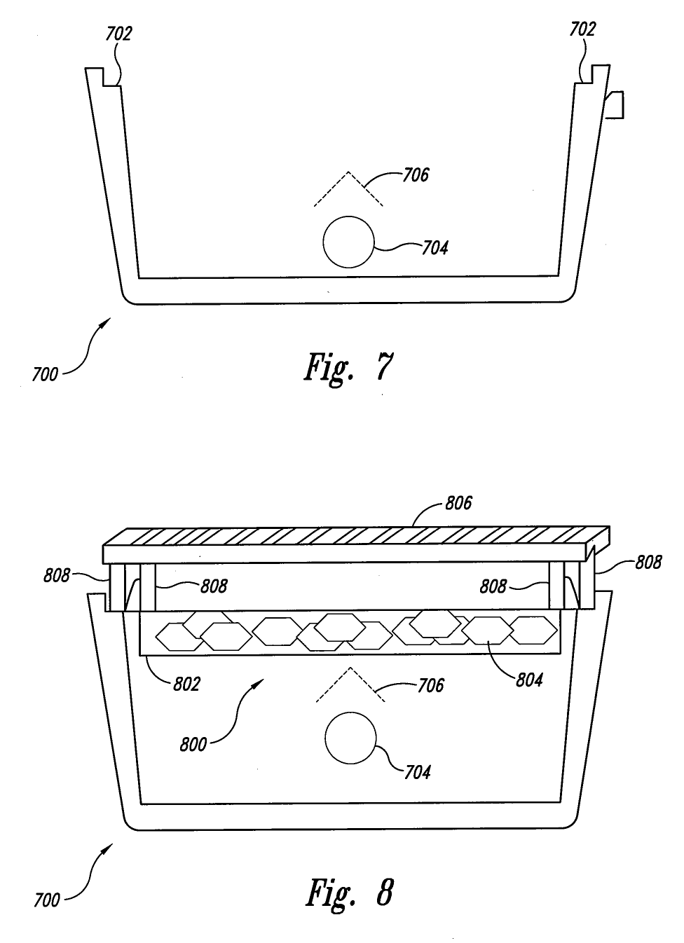

In general, the indirect/warming surfaces (506, 508, and 604) shown in FIGS. 5 and 6 allow for alternatives to the grilling surfaces (502, 504, and 602) when heating or cooking a variety of foods at the same time or when cooking foods having multiple cooking stages that require more than one type of cooking surface. For example the indirect/warming surfaces (506, 508, and 604) may be used to cook vegetables on the grill assembly (500 or 600) without requiring a separate tray for doing so and without the risk of losing the vegetables through the grill grate. In another example, the indirect/warming surfaces (506, 508, and 604) allow meats to be cooked through select stages without having to move coals away from underneath the meat or move the meat away from a gas burner, or, if there are two gas burners, reducing the cooking space available for other foods being prepared. Another use for the indirect/warming surfaces (506, 508, and 604) is to keep already cooked foods warm, while minimizing the risk of overcooking. The indirect/warming surfaces (506, 508, and 604) may be heated via a single heat or source or possibly a combination of heat sources, including a combination of heat sources such as those described below with respect to FIGS. 7-9.

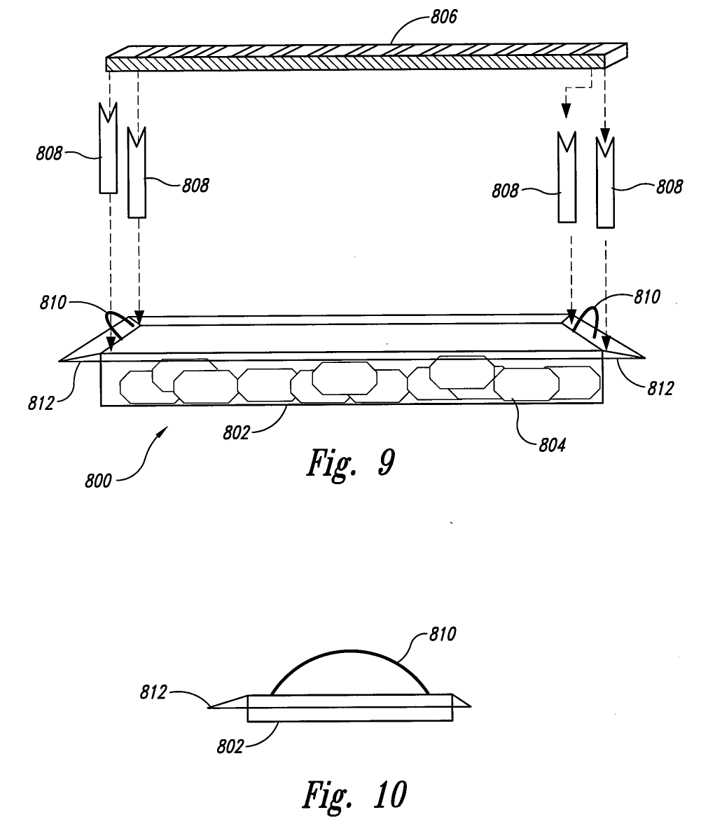

FIG. 7 is a side plan view of a sample grill assembly firebox 700, including a shelf feature 702 configured to accommodate either a typical grill grate or an alternative fuel tray/grill grate assembly 802 as shown FIGS. 8 and 9. The firebox 700 of FIG. 7 also includes a gas burner 704 and a heat displacer 706. While not shown, in an alternative embodiment, the firebox/grill base includes multiple shelf features including a top shelf to support a standard grill/cooking surface and a lower shelf that, if used to support an alternative fuel source tray, would locate the alternative fuel source tray between the burner/heat displacer and the standard grill/cooking surface. For example, such a firebox/grill base may include a primary heating element (e.g., gas burner) arranged to emit heat upward to a cooking surface and may also include supporting features (e.g., a support groove, support bracket, or support shelf, similar to the shelf feature 702 of FIG. 7) that supports the alternative fuel tray between the primary heating element and the cooking surface, such that when an alternative fuel source combusts while being supported in the alternative fuel tray, heat from the combustion of the alternative fuel source is emitted upward toward the cooking surface. Such a firebox/grill base may also include an opening (e.g., in the side or on the top of the firebox/grill base) (not shown) for receiving the alternative fuel tray so that the alternative fuel tray can be removed and inserted from the grill base as needed. For example, the removable fuel tray may be removed from the grill base/firebox when cooking exclusively with gas or when the tray needs to be cleaned or emptied of used fuel.

FIG. 8 is a side elevation view of the sample grill assembly firebox of FIG. 7, with an alternative fuel tray/grill grate assembly 800 inserted. FIG. 9 is a side elevation view of the sample disassembled alternative fuel tray/grill assembly 800 of FIG. 8. The alternative fuel tray/grill grate assembly 800 is placed on the shelf 702 of the firebox 700 above the gas burner/heat displacer (704 and 706). The alternative fuel tray/grill grate assembly 800 allows for select preparation of food by charcoal or other alternative fuel, despite the fact that the grill assembly is also designed as a gas grill. The tray portion 802 of the alternative fuel tray/grill grate assembly 800 may be without holes and completely seal the gas burner/heat displacer (704 and 706) from the charcoal/alternative fuel source 804, thus, preventing ashes from damaging the burner/heat displacer (704 and 706). There is no need to remove or displace the gas burner/heat displacer (704 and 706), as the tray portion 802 sits above them.

A grill grate 806 then sits above the tray portion 802, and can be raised above the alternative fuel source 804 (e.g., charcoal briquettes) via grill posts 808. The grill posts 808 are of sufficient height to accommodate the proper distance between the alternative fuel source 804 and the food being cooked, and in some embodiments, may be adjustable. The grill posts 808 are designed to allow the grill grate 806 to easily be inserted into the grill posts 808 and to provide stability for the grill grate 806.

As shown in FIGS. 9 and 10, some embodiments of the alternative fuel tray/grill grate assembly 800 include handles 810 to allow for easy insertion/extraction of the tray portion 802, ease of inserting the grill grate 806 into the grill posts 808, and easy clean-up of spent alternative fuels (e.g., dumping of cold ashes upon completion of use). In the illustrated example, the handles 810 are affixed to the tray portion 802, shown in FIG. 9 on two opposing sides. A supporting member 812 located on two or more sides of the tray portion 802 (or otherwise around its exterior) may slide or be placed into and rest on top of the firebox shelf feature 702, which is most clearly depicted with respect to FIG. 7. In many cases, the design of the supporting members 812 allows the alternative fuel tray/grill grate assembly 800 to be utilized in many conventional/existing gas grills. For example, in one embodiment, the supporting members 812 allow the alternative fuel tray to be horizontally placed into or onto at least one support feature (e.g., a support groove, support bracket, or support shelf, similar to the shelf feature 702 of FIG. 7) in a base portion of a barbeque grill that is also suitable to support a standard grill cooking surface at times when the barbeque grill is used with only with a primary fuel source.

In some embodiments, it is possible for the alternative fuel tray to be used in combination (either simultaneously or in sequence) with a primary heating element. For example, it may be possible to use a gas-based primary heat source to preheat charcoal placed on an alternative fuel tray. In another example, a gas-based primary heat source may be used to heat a first cooking surface (e.g., the left-hand portion of the corner grill assembly 100 of FIG. 1) while the heat from the alternative fuel tray is used to heat another cooking surface (e.g., the right-hand portion of the corner grill assembly 100 of FIG. 1). In yet another example, a gas-based primary heat source may be used to keep food warm after it has been fully cooked using heat produced from the alternative fuel tray.

The grill, the indirect/warming shelf and the alternative fuel tray insert may all be manufactured using current steel, stainless steel, cast iron, or similar metals/materials used currently in the manufacture of grills. The materials used to construct the features of the grill, the indirect/warming shelf and the alternative fuel tray insert may be specially treated as needed to withstand high levels of heat. In general, many different manufacturing materials (including non-metal materials) and processes may be utilized without departing form the scope of the invention.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I claim:

1. An alternative fuel tray assembly for use in a barbeque grill, the alternative fuel tray assembly comprising:
an alternative fuel tray configured to hold a first fuel source for producing heat used to cook food, the alternative fuel tray having one or more supporting members on portions of its exterior that allow the fuel tray to be placed into or onto at least one support feature of the barbeque grill, wherein the barbeque grill is primarily configured to cook food using heat from a second fuel source that is distinct from the first fuel source, and wherein the at least one support feature is also suitable to support a standard grill cooking surface at times when the barbeque grill is used with only the second fuel source;
a cooking surface for use with the alternative fuel tray; and
one or more cooking surface placement features configured to support the cooking surface above the alternative fuel tray at an orientation to allow cooking of food placed on the cooking surface by heat resulting from the first fuel combusting in the fuel tray.

2. The alternative fuel tray assembly of claim 1 wherein the one or more cooking surface placement features include multiple support posts.

3. The alternative fuel tray assembly of claim 1 wherein the at least one support feature includes shelf features located on at least two opposing sides of the base portion of the barbeque grill.

4. The alternative fuel tray assembly of claim 1 wherein the first fuel source is charcoal or wood.

5. A cooking grill system comprising:
a cooking surface;
a removable alternative fuel tray; and
a grill base comprising:
at least one primary heating element configured and arranged to emit heat toward the cooking surface, wherein the emitted heat is produced via combustion of a first fuel source; and
one or more support features for supporting, between the primary heating element and the cooking surface, the alternative fuel tray such that when an alternative fuel source combusts while being supported in the alternative fuel tray, heat from the combustion of the alternative fuel source is emitted toward the cooking surface.

6. The cooking grill system of claim 5 wherein the first fuel source is a gas or liquid fuel and wherein the alternative fuel source is charcoal or wood.

7. The cooking grill system of claim 5 wherein the position of the cooking surface relative to the primary heating element is adjustable.

8. The cooking grill system of claim 5, further comprising an indirect cooking shelf distinct from the cooking surface, and configured to receive heat from at least one heat source associated with the grill base.

9. The cooking grill system of claim 5 wherein the heat from the primary heating element and heat from the combustion of the alternative fuel source are used in combination to cook or warm foods.

10. The cooking grill system of claim 5 wherein the grill base further comprises an opening for receiving the removable alternative fuel tray.

11. A movable cooking grill system comprising:
a first leg having a first grill portion; and
second leg having a second grill portion connected to the first leg, wherein the first leg and the second leg are generally oriented in an approximate L-shape, thereby forming a user working area between the first leg and the second leg adjacent to the first and second grill portions.

12. The movable cooking grill system of claim 11 wherein the first leg comprises a firebox assembly that includes a cooking surface and at least one heating element configured to emit heat toward the cooking surface to cook foods, and wherein the second leg includes a storage cabinet.

13. The movable cooking grill system of claim 11 wherein the first leg and the second leg each comprises a firebox assembly that includes a cooking surface and at least one heating element configured to emit heat toward the cooking surface to cook foods.

14. The movable cooking grill system of claim 11 wherein both the first leg and the second leg each include a primary cooking surface.

15. The movable cooking grill system of claim 14, further comprising at least one secondary cooking surface configured for indirect heating of food items and warming of food items.
